(19) United States
(12) Patent Application Publication
(10) Pub. No.: US 2010/0297520 A1
(43) Pub. Date: Nov. 25, 2010

(54) ELECTROCHEMICAL ENERGY CONVERSION SYSTEM

(75) Inventors: Heinz Wenzl, Osterode (DE); Hanno Stagge, Clausthal-Zellerfeld (DE); Ralf Benger, Windhausen (DE); Hans-Peter Beck, Goslar (DE)

Correspondence Address: HUDAK, SHUNK & FARINE, CO., L.P.A., 2020 FRONT STREET, SUITE 307, CUYAHOGA FALLS, OH, 44221, US

(73) Assignee: Heinz Wenzl, AM Bergwaeldchen 27, Osterode (DE)

(21) Appl. No.: 12/734,954

(22) PCT Filed: Dec. 4, 2008
(86) PCT No.: PCT/EP2008/010272

§ 371 Date: Jun. 28, 2010

(30) Foreign Application Priority Data
Dec. 5, 2007 (DE) 10 2007 058 837.4

(51) Int. Cl. H01M 8/24; H01M 4/64

(52) U.S. Cl. 429/452; 429/518

(57) ABSTRACT

In an electrochemical energy conversion system with at least one electrically conducting component with at least two cells connected in series, at least one of the electrically conducting components is divided into at least two segments which are electrically insulated from one another, and a transfer plate, consisting of electrically non-conducting material with at least two conducting sections and/or areas is provided to conduct currents from at least one segment to at least one other segment. A transfer plate for such an electrochemical energy conversion system consists of electrically non conducting material and exhibits at least two electrically conducting sections and/or areas.

### FIELD OF INVENTION

The invention concerns an electrochemical energy conversion system with at least one electrically conducting component with at least two cells connected in series.

### BACKGROUND OF THE INVENTION

Electrochemical energy conversion systems are, in this context, in particular electrometallurgical and galvanic plants, electrolytic plants, batteries, double layer capacitors and fuel cells, where current flows in electron and ion conducting components such as, for instance, end plates, bipolar plates, electrolyte, gas diffusion layers, etc. which have large cross sections. The current distribution in such systems is even under stationary or quasi stationary conditions very inhomogeneous. Simulations and Measurements both show that under normal operating conditions the local current density in the components may differ from an average value by more than a factor of two, as disclosed by Sauer & Sanders: “Spatially resolved current, temperature and potential measurement and modeling in fuel cells as basis for ageing models, workshop lifetime prediction of fuel cells, Ulm, Germany, 2007, by Freunberger, Reum, Evertz, Wokaun, Büchi: “Measuring the current distribution in PEFCs with Sub-Millimeter resolution”, Journal of the Electrochemical Society, 153, 2006, and by Brett, Atkins, N. P. Brandon, Vasileiadis, Vesovic, A. R. Kucernak: “Membrane resistance and current distribution measurements under various operating conditions in a polymer electrolyte fuel cell”, Journal of Power Sources 172, 2007. The current distribution inhomogeneity is the result of minor differences in the electrical resistances of the individual components, such as, for instance very small thickness variations, contact resistances, such as, for instance, local variations of contact pressure between two electrodes, the concentration of the reactants at the reaction site with its impact on the equilibrium voltage, and local inhomogeneity of materials. The local concentration of the reaction partners respectively reactants as in electrolyzers, electrometallurgical and galvanic plants, batteries and redox-flow-cells, respectively fuels as in fuel cells affects the local voltage level. As result of the voltage differences, compensation currents flow within the electrochemical energy conversion system in a state of rest which cannot be measured at the connecting terminals.

Furthermore phenomena have been found which occur both in fuel cells as well as in batteries and indicate the existence of ring currents within one electrode or between two electrodes, as the current direction may be different if there are voltage differences in different areas of the electrode. In batteries, one region of the electrode will be charged by means of discharging another region of the electrode, in fuel cells regions of the electrode will experience current flow in the wrong direction and will be severely damaged, as has been disclosed by Johnson, Gemmen: “Effect of load transients on SOFC operation—current reversal on loss of load”, Power Sources 144, 2005.

When current flows through the electrochemical energy conversion system and external loads or chargers, the differences in local voltage lead to significantly different local current densities. Differences in the current density lead to differences in the heat generation which leads to significant local temperature differences within the electrochemical energy conversion system because the heat transfer conditions from the inside of the electrochemical energy conversion system to the outside are poor in known electrochemical energy conversion system for design reasons. The temperature differences in turn affect the current distribution, as the electrochemical voltage sources and some of the electrically conducting materials of electrochemical energy conversion systems have a pronounced and partly also non-linear dependence of the electrical resistance on the temperature. Ageing processes, e.g. of the micro structure and the chemical composition of the materials of the electrochemical energy conversion system depend strongly on the temperature and the current density at the respective locations within the electrochemical energy conversion system. An inhomogeneous current and temperature distribution therefore leads to local differences in the rate of ageing and a reduction of the capability of the electrochemical energy conversion system, because the maximum capability cannot be utilized in regions with lower temperature and current load and the total capability needs to be restricted to the maximum acceptable local temperature and current density values in those regions with the highest temperature and current load.

In all electrochemical energy conversion systems in which local differences of the concentration of the reactants can occur or the current homogeneity across the electrode area is not adequate for other reasons, it is well known to employ design-engineering countermeasures. In Nickel-Metal hydride (NiMH) batteries for hybrid vehicles it is for instance known to contact the electrodes at a number of different places in order to achieve a more uniform current distribution. In lead acid batteries for instance, where the electrolyte is also one of the reactants, the electrolyte is mechanically mixed to create a more uniform concentration.

In the following, electrochemical energy conversion systems in the general structure of bipolar systems, in particular fuel cells will be discussed first.

For fuel cells and redox-flow-cells it is well known to optimize the flow field so that the concentration of the fuels across the electrode becomes as uniform as possible. Particularly in fuel cells it is state of the art to achieve uniformity by means of the form of the flow field in the gas distribution plates—respectively in fuel cells with Methanol as fuel in the distribution plates for the liquid—and by means of the number and position of the fuel inlet and outlet ports.

Different investigations concerning in situ measurements of the current and temperature distribution have also been carried out. However, no solutions in the state of the art have been found which solve the problem of the inhomogeneous current density and temperature distribution in any other way than the optimization of the flow fields and the number fuel inlets.

DE 10 2004 014 493 A1 discloses a process for measuring the current density distribution in a fuel cell or a fuel cell stack, in which a conducting plate divided into segments like a matrix is situated within the fuel cell, and where each segment is electrically contacted by means of a wire or cable and all segments in a row are contacted first with a first wire in series and all segments in a column are contacted with a second wire in series. Furthermore, at least one segment which serves as reference is contacted additionally by two separate contact wires. Current flowing through a segment generates a potential difference in one segment and the potential differences of all segments lead to a voltage differences in the wires which are contacted to the segments along the rows and columns and this voltage difference can be measured at the ends of the wires. Additionally the voltage difference at the two separate contact wires of the reference segment is measured and the distribution of the voltage differences at the end of the wires which are contacted to the segments along the rows and columns is used to determine the current density distribution of the segments whereby the current density distribution of the reference segment is used for the calculation.

DE 103 23 644 A1 discloses a channel structure for PEM fuel cells which is designed with local differences to adjust the gas flow to the membrane electrode structure. The active gas volume flow is changed locally by variation of the number and/or cross section of the gas channels per unit area and is reduced from the cathode inlet port to the cathode outlet port.

In DE 103 92 974 T5 a resistive circuit is disclosed for the measurement of the current and temperature distribution of a fuel cell in situ. According to this, a sensor arrangement is provided for measuring an operating parameters of a fuel cell, with a first plate with flow field which is segmented into a large number of electrically insulated areas, a second plate with flow field and a conducting plate between the first and the second plate with a flow field and contains resistors, so that each of the large number of electrically insulated areas is assigned to one resistor for measuring the current flowing through the electrically insulated areas.

DE 10 2005 002 174 A1 discloses a fluid distribution layer, e.g. for the membrane of a fuel cell, and a procedure for its manufacture. For this a three dimensional system of channels for the transport of a fluid is provided, whereby the channels running in different dimensions are connected at defined points to allow an exchange of fluids. The system of channels exhibits on a first surface of the layer outlets so that fluid which is fed into the other surface of the layer inhomogeneously is distributed by the system of channels. As a result, fluid exits from all outlets of the first surface of the layer. This is intended to lead to an essentially homogeneous fluid system as regards the first surface.

DE 10 2004 016 318 A1 discloses a bipolar plate as well as a process for its manufacture and an electrochemical system containing a Bipolar plate, where a first plate with a first flow field for the media distribution as well as a second plate with a second flow field for the media distribution is provided. The first plate exhibits in the area of the first flow field a first section, on which there are distributed discrete elevations separate from one another.

DE 11 2005 001 970 T5 discloses an embossed bridge and plate for the supply of reactants for a fuel cell, where one plate, which exhibits an edge with an opening leading from one side to the other and a flow field contained in the area of the plate, and a bridge element in a sealing-off contact with the edge and surrounding the opening is provided in order to create an elevated area around the opening. The bridge element exhibits a set of integrally formed connections in order to create a fluid connection between the edge and the elevated area from the opening to the flow field.

In DE 10 2004 014 114 A1 a device is disclosed for measuring the current density distribution in fuel cells, in which at least one fuel cell is provided with two bipolar plates, a membrane electrode assembly and an end plate. Furthermore, there is provided at least one segmented, conducting plate which is positioned between the bipolar plate and the end plate, and each segment of this plate is electrically contacted by means of two wires and contact points. After measuring the current density distribution, the segmented plate and the other plates are again removed.

DE 10 2004 026 134 B4 discloses a gas distribution plate for a fuel cell and a fuel cell containing such a plate, where parallel channels conducting the gas are provided in a meander type structure and where bars with variable width between the outside channels of the parallel channels with opposite direction of gas flow are provided in order to reduce the media transfer along the outside channels, whereby the width of the gas conducting channels is constant.

DE 10 2006 017 064 A1 discloses a fuel cell stack with a large number of fuel cell modules stacked next to each other, where each of the modules consists of a number of fuel cells oriented in parallel to each other and connected electrically in series. The current flow between neighboring fuel cells is achieved by means of a diffusion medium. The current path specified for the flow of electrons leads essentially through the diffusion medium which carries out the fuel transport and the removal of the reaction products.

In conventional fuel cells connected in series, electrons also flow through the diffusion medium respectively the gas diffusion layer, however vertically to the diffusion medium and only for fractions of a millimeter per cell. The electrical resistance of the diffusion medium therefore is very small. In the solution described in DE 10 2006 017 064 A1, however, the path of the electrons through the diffusion layer is much longer.

If the current changes over time, there is in particular for fuel cells in applications with high power dynamics the further problem that, although the supply of fuel can be controlled virtually immediately proportionally to the total current, the effect inside of the fuel cell at the reaction site only appears with a time delay. During a change in current and the change in fuel supply therefore, there will always be regions in which the local concentration of fuels is either too high or too low and does not correspond to the optimum under stationary conditions. To solve this problem, there are different strategies according to the state of the art, for instance limiting the power gradient, as disclosed in DE 101 09 151 A1. Furthermore control algorithms have been discussed to adjust the fuel supply to the momentary power and power gradient.

Where there are very fast changes in current, e.g. as a result of switching operations of semi conductor elements, or where there is a superposition of the direct current flowing through the electrochemical energy conversion system with alternating current as a result of inverters, motor control units, etc., skin effect or current displacement effects can be expected, to which belongs the so-called transient skin effect. The transient skin effect is discussed using a cylindrically conducting rod as an example by Hannakam: “Calculation of the transient current distribution in a Cylinder”, ETZ-A 91, 1970. Ropeter has shown in his dissertation “Properties of batteries under pulsed current conditions with special consideration of the skin effect”, Institute for Electrical Power Engineering, TU Clausthal, 2007, using batteries as examples that such current displacement effects, in particular the transient skin effect phenomenon, which can appear during switching operations, can be utilized for heating batteries and the inhomogeneous current distribution in electrodes of batteries, which is caused by superimposed alternating currents, must not be neglected.

### SUMMARY OF THE INVENTION

The present invention therefore has the task to avoid current and temperature inhomogeneities in an electrochemical energy conversion system, and in particularly to ensure a homogeneous current flow.

The task is solved for an electrochemical energy conversion system according to the claims in such a way that at least one of the electrically conducting components is divided into at least two segments which are electrically insulated against each other and at least one transfer plate, consisting of non conducting material with at least two conducting sections and/or areas, is provided for conducting current from at least one segment to at least one other segment. The task will be solved furthermore for a transfer plate in such a way, that the transfer plate consists of electrically non conducting material and at least two electrically conducting sections and/or areas. Embodiments of the invention are defined in the further claims.

As a result, an electrochemical energy conversion system is created, in which the individual electrically conducting components of the electrochemical energy conversion system or at least one of the components is divided into segments which are insulated against each other. Furthermore, the transfer plate is integrated into the electrochemical energy conversion system. This not only leads to a more homogeneous current flow in the electrochemical energy conversion system, e.g. of electrolysers, fuel cell stacks, redox-flow-batteries and other electrochemical energy conversion systems with comparable construction, but also prevents that current in electrodes and electrolyte can flow opposite to the preferential direction during current flow, even if this effect would appear only seldom and only for a few seconds. Damage to the electrochemical energy conversion system, which may occur as a result of a wrong current direction, will thus be prevented advantageously. A more homogeneous current distribution in the electrically conducting components, in particular of electrodes pf a fuel cell stack, leads to a more homogeneous temperature of the electrodes with lower temperature maxima. As a result, temperature dependent ageing processes will be slowed down and the danger of exceeding temperature limits locally, which otherwise may lead to a destruction of the electrodes or more generally the electrically conducting components, will be avoided or at least reduced. As a result of the more homogeneous current density distribution, a more uniform utilization of fuel becomes possible respectively the deposition in electrometallurgical or galvanic plants becomes more uniform. Because of the more uniform fuel utilization, the risk of a local fuel deficiency and the resulting acceleration of ageing processes can be reduced. During stationary operation or changes in the power output of the electrochemical energy conversion system the temperature gradients within the electrochemical energy conversion system can be reduced. Temperature gradients will then have a lower impact on the lifetime of the electrochemical energy conversion system.

As a result of the more homogeneous reaction processes, the electrical efficiency of the electrochemical energy conversion system can be improved.

For the “high resistant” short circuit, which exists in DE 10 2006 017 064 A1, considerable voltage and efficiency reduction must be expected. The current path for the electrons leads exclusively through the diffusion layer and amounts to a few centimeters per cell, if usual dimensions of fuel cells are assumed. The electrical resistance and thus the voltage drop along the diffusion layer are therefore higher by a multiple and the efficiency of the cell will thus be considerably lower than that of the electrochemical energy conversion system according to the present invention.

The analysis of Ropeter (see above) does not include fuel cells or switching-off operations in fuel cells. The occurrence of ring currents in a fuel cell stack in case of fast switching-off operations o unfavorable fuel composition does not have to be taken into account any more when providing a separation of the electrically conducting components into segments, which are electrically insulated against each other, and providing a transfer plate to conduct current from one segment into another.

Advantageously, in an electrochemical energy conversion system there are provided between each of the segments at least one electrically insulating separating element. The separating element can be designed differently, e.g. in the form of a thin separating layer with good thermal conductivity. As a result of the electrical separation by means of a separating element, voltage differences between the individual segments of the electrically conducting components, such as, for example, of bipolar plates, can be purposely created. To allow voltage differences is advantageous, so that similar currents can flow in the individual segments, although differences in fuel concentration cause different electrode potentials.

However, it is also possible to utilize the lateral resistance of the component which is much larger compared to the through resistance in order to maintain a voltage difference between the segments. The through resistance of the individual electrically conducting components is determined by the very large cross section and the very small thickness, the lateral resistance, however, is determined by a very small cross section and great length. Components of fuel cell systems for mobile applications or domestic energy supply systems typically have a cross section F of ca. 10×10 to 20×20 cm² and a thickness d of ca. 0.1 mm (electrolyte) or max. ca. 2 mm (bipolar plate). The resistance is calculated according to ρ×d/F. For the through resistance of a segment, d/F is ca. 10⁻³ to 10⁻⁵ cm⁻¹. For an estimate of the lateral resistance assumptions concerning the relevant length and cross section have to be made. As length, for instance the distance between the centers of adjacent segments can be used, e.g. 4 cm, and as cross section the lateral cross section of the component, e.g. 0.1 cm (thickness of component)×10 cm (length of component). The ratio d/F is then 4 cm⁻¹. When considering usual designs of fuel cell stacks, very large differences between the lateral and through resistance are the result. Alone by utilizing the lateral resistance, voltage differences between the segments of the electrically conducting components, such as e.g. of bipolar plates, can be achieved systematically. It is clear that the current in the lateral direction will only have a noticeable amplitude if there are significant voltage differences between the segments. Waiving electrically insulating separating elements in the components in favor of the utilization of the lateral resistance as high resistance separation can simplify the overall design considerably.

When arranging for instance fuel cells in series, the separating elements are advantageously arranged on top of each other so that the current flow takes place from one cell to the next always in the same segment till the transfer plate.

It is advantageous to divide at least one electrically conducting component into two half components of equal area but half the thickness, which are separated from each other, in order to be able to install between them a transfer plate. For example, a bipolar plate, which similar to electrolyte and gas distribution layer exhibits a low lateral resistance, as electrically conducting component of an electrochemical energy conversion system is divided into half bipolar plates. The half bipolar plates are divided either by means of separating elements or a low lateral conductivity into segments.

The design of half components respectively half bipolar plates is used for the connection to the transfer plate, which is placed between the half components to achieve a more uniform Current density distribution in the electrochemical energy conversion system. The transfer plate enables the current flow between the individual segments of the electrically conducting half components, the segments being either insulated against each other by separating elements or connected with a high resistance due to the low lateral conductivity. As a bipolar plate can be modified and machined quite easily, it is particularly suitable as half component and for combination with a transfer plate.

As alternative to the use of separating elements for creating segments, which are electrically separated from one another, an electrically conducting component, in particular a bipolar plate of a fuel cell stack, can also be manufactured from electrically anisotropic conducting material, the electrical conductivity of which is high in the direction vertical to the cross section and low in the other directions. A reduction of the conductivity in the lateral direction by a factor of two in relation to the conductivity in the through direction would increase the lateral resistance by a factor of 2 and create an even higher resistance electrical connection between the segments, thus approaching the properties of separating elements as regards the electrical insulation of the segments even better. Such an anisotropic property can be obtained e.g. in bipolar plates made from graphite or from plastics filled with electrically conducting additives by means of adding thin, electrically non-conducting or poorly conducting platelets, which are oriented preferentially vertical to the large surface area of the electrically conducting component as a result of the production process. In addition, the distribution of such platelets in the component can be made non-uniform in the production process so that the desired borders of the segments can be created and the lateral conductivity between the individual segments is increased further compared to the lateral resistance when using material with isotropic conductivity.

The negative impact of the skin effect and the transient skin effects, where current displacement effects occur if there are very fast current changes, can be reduced by an optimized shape of the segments and the transfer plate. Advantageously, the electrically conducting component is designed in such a way that the lateral conductivity of the electrically conducting component decreases in radial direction from the enter to avoid the transient skin effect. This can be achieved by utilizing an anisotropic conducting material, the conductivity of which decreases in radial direction from the middle, e.g. by adding non-conducting or poorly conducting platelets to the material of the respective electrically conducting component. Furthermore, a preferred embodiment is that at least one segment is located in the middle of a cell surrounded by the other segments, so that the current paths through the electrochemical energy conversion system by means of transfer plates are specified advantageously in such a way that each current path leads both through segments on the outside and the segment or segments in the inside. To ensure that the formation of the transient skin effect cannot occur in parts of the electrochemical energy conversion system, in particular of a fuel cell stack, the current path should lead frequently from an outer to an inner segment. When specifying the current paths, it is advantageous to take into account the material properties of the material employed for the electrically conducting components, the thickness of each component, the number of cells and the current gradient which will exist during switching operations. The skin depth of alternating current with frequency ω is inversely proportional to the root of the product of frequency, electrical conductivity and permeability of the materials.

It is also possible to make the segments, which are created either by separating elements or anisotropic conducting materials, of different size and arbitrary shape, which should, however cover the area of the electrically conducting components fully and without overlap. For the purpose of optimization, the shape and size of the segments can be changed for different cells.

It is advantageous that the electrically conducting sections of the transfer plate are electrically insulated from one another. This separation can be provided also without insulation between the electrically conducting segments and/or areas of the transfer plate if only the lateral resistance acts like a separating element between the electrically conducting areas/sections. Whether an electrical separation by means of insulation is provided or a separation by utilizing the lateral resistance can be chosen application specific, whereby the quality of the separation depends on the size of the lateral resistance. If the lateral resistance is very low due to the use of thick and well conducting materials, a separation by means of insulation will be more favorable.

Between the electrically conducting sections and/or areas of the transfer plate connecting elements are provided and insulated against each other. By providing such connecting elements, it is possible to create any desired connection between the electrically conducting sections and/or areas on different sides of the transfer plate. In one modification, the connecting elements can be cables, where the resistance of the cables should correspond to each other or be similar, particularly if a number of cable connections are provided. Furthermore, the connecting elements can be essentially flat elements which are connected to the conducting areas of the transfer plate and have a similar resistance. By providing connecting elements, which have essentially the same resistance, current can be passed from one electrically conducting area to the others with approximately the same voltage drop for each section.

The connecting elements can be positioned on the outside of the transfer plate, to conduct current from one segment to the next. Alternatively the connecting elements can also be arranged inside of the transfer plate. In addition, it is possible to arrange some of the connecting elements inside and some outside of the transfer plate. The connecting elements can be located advantageously on the point of the section which has overall the lowest resistance to the current flowing into the section and being conducted away via the connecting element. In many cases, this will be the electrical center of the respective section/area, whereby the term electrical center is to be understood as that point which has in relation to the total resistance of a point connection of a conducting area the lowest resistance. The points to which the connecting elements are attached to on the electrically conducting areas can also be specified application specific.

Advantageously, the bulk body of the transfer plate consists of an electrically non-conducting material, in particular partly of air, which means that the transfer plate is formed partly as a hollow body. In this way, a particularly good insulation, a cost effective solution and a low weight of the transfer plate are possible.

It is particularly advantageous if the transfer plate forms a design unit with at least one bipolar plate. In this way, a compact unit, which can be simply integrated into the electrochemical energy conversion system, can be created. In principle, the unit can be formed in such a way that the bipolar plate is already provided with the function of the transfer plate. For example, the electrically conducting sections and/or areas of the transfer plate can be formed such that the same surface structure and surface treatment as those of a bipolar plate are used.

In an alternative, or additionally to the use of a transfer plate, proposed solution for achieving a homogeneous current in the electrochemical energy conversion system, at least one power electronic component is provided, so that the current density distribution can be influenced by means of the power electronic component. To achieve this, the current density in the segments of the electrically conducting components respectively the Potential of the segments compared to a reference electrode or the current in a reference segment is measured and, depending on the aim of the optimization, the current density or the potential of the respective segment will be converted to higher or lower voltages by means of at least one power electronic des component. The power electronic components can be placed either between two cells and/or at the beginning and/or end of a (fuel cell) stack, or in general terms, the electrochemical energy conversion system. Advantageously, an end plate, which is divided into electrically separated segments, of the electrochemical energy conversion system is provided to which the power electronic component can be connected. For a fuel cell stack the power electronic component is advantageously arranged on the side of the end plate which points away from the fuel cell stack because this will minimize the design intrusion into the fuel cell stack, and even a position of the power electronic component outside the fuel cell stack at another favorable place is possible.

Advantageously, the power electronic component is integrated at least in one current path between the segments of at least one electrically conducting components or can be integrated to adapt the voltage essentially with low losses. The power electronic component can pass the power which it takes up to at least one other electronic component between other segments and/or provide power for the operation of auxiliary systems.

In a further alternative or additional utilization of transfer plates and/or power electronic components, it is proposed that the fuel supply will be designed in such a way that the fuel will flow through the segments in a changing sequence so that the currents in the electrochemical energy conversion system will become more homogeneous.

### BRIEF DESCRIPTION OF THE DRAWINGS

In order to describe the invention in more details, the following embodiments are described using the figures below. These show in:

FIG. 1 Schematic diagram of an electrochemical energy conversion system in the form of a fuel cell stack,

FIG. 2 Equivalent circuit diagram of a fuel cell stack according to FIG. 1,

FIG. 3 Schematic diagram of a fuel cell stack with separation of the electrically conducting components into three segments according to the invention,

FIG. 4 Equivalent circuit diagram of fuel cell stack according to FIG. 3,

FIG. 5 Perspective view of a bipolar plate with three conducting segments and two separating elements,

FIG. 6 Perspective view of the bipolar plate according to FIG. 5 with a separation into two half bipolar plates,

FIG. 7 Perspective view of a transfer plate with three segments an a connecting cable provided inside according to the invention,

FIG. 8 Perspective view of a modification of the transfer plate according to FIG. 7, with externally attached connecting cables,

FIG. 9 Perspective exploded view of parts of a transfer plate with flat connecting elements between the segments of the transfer plate,

FIG. 10 Schematic diagram of a fuel cell stack with a transfer plate according to the invention,

FIG. 11 Equivalent circuit diagram of a modified bipolar plate with transfer plate of the fuel cell stack according to FIG. 10,

FIG. 12 Schematic diagram of a second embodiment of a fuel cell stack with two transfer plates according to the invention,

FIG. 13 Perspective view of a fuel cell stack with alternative lay out of connecting cables to avoid transient skin effects,

FIG. 14 Schematic diagram of a fuel cell stack with power electronics based buck and boost converter, and

FIG. 15 Schematic diagram of a fuel cell stack with division of the electrically conducting Components into three segments showing the fuel supply to different segments according to the invention.

### DETAILED DESCRIPTION OF THE INVENTION

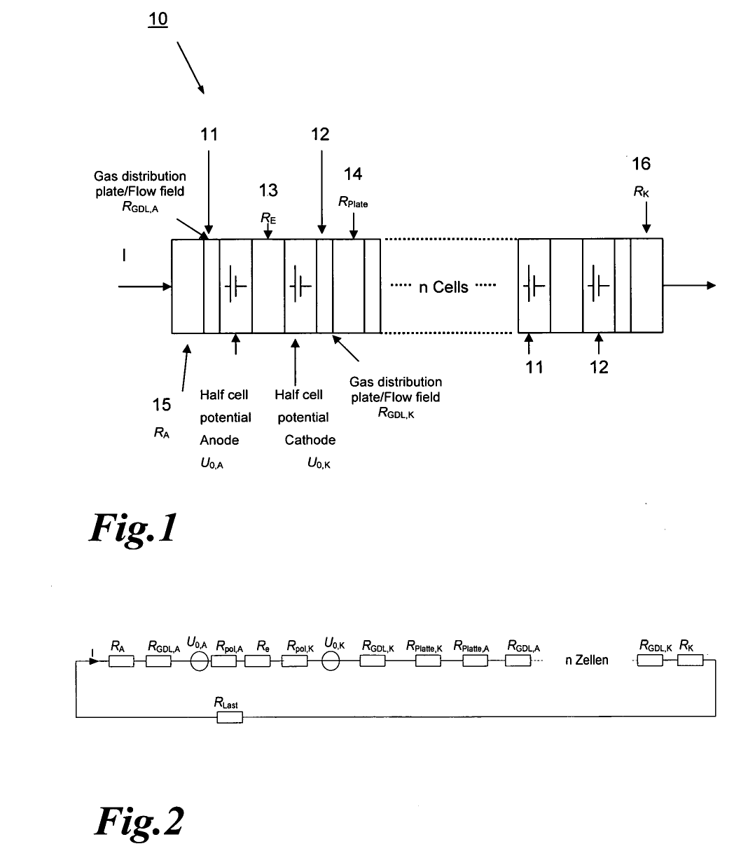

FIG. 1 shows a known construction of a fuel cell stack 10 with bipolar plates, FIG. 2 the corresponding electrical equivalent circuit diagram. The fuel cell stack 10 consists of n cells, each with a fuel anode 11, a fuel cathode 12, electrolyte 13 in between, a bipolar plate 14 and gas diffusion layers. All of these elements are represented in the equivalent circuit diagram as resistors, similar to the resistor representing the charge transfer of the electrochemical reaction and the electrochemical voltage source, which are designated as anodic and cathodic voltage source, whereby in FIG. 1 the half cell potential of the anode and cathode is indicated. The fuel cell stack exhibits furthermore an anode end plate 15 and a cathode end plate 16. The indices K and A chosen for the equivalent circuit diagram are for the cathode and anode respectively. The charge transfer resistance Rₚₒₗ in the equivalent circuit diagram is also shown for the anode and cathode.

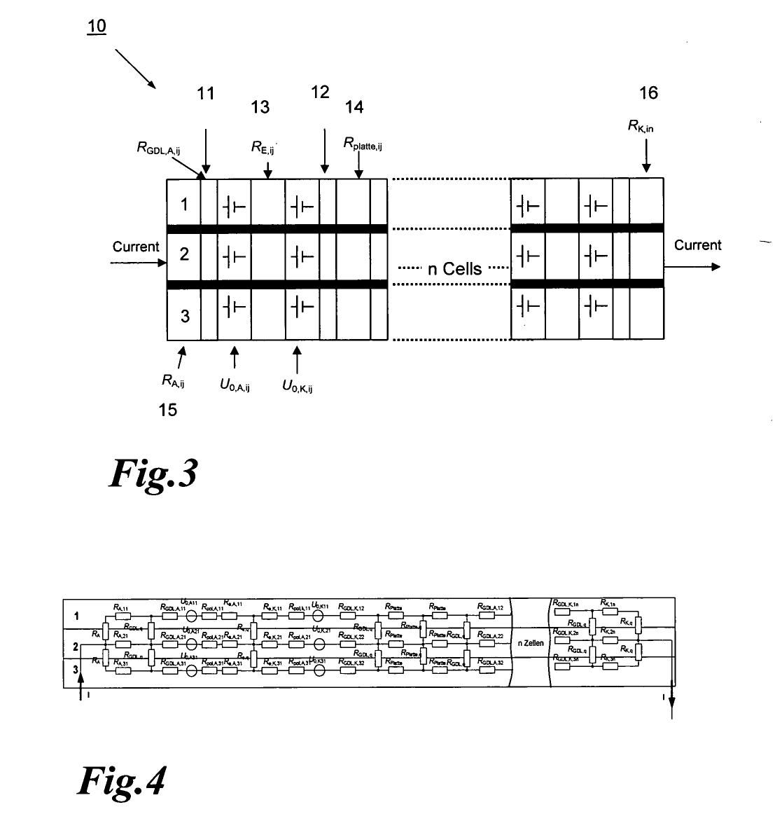

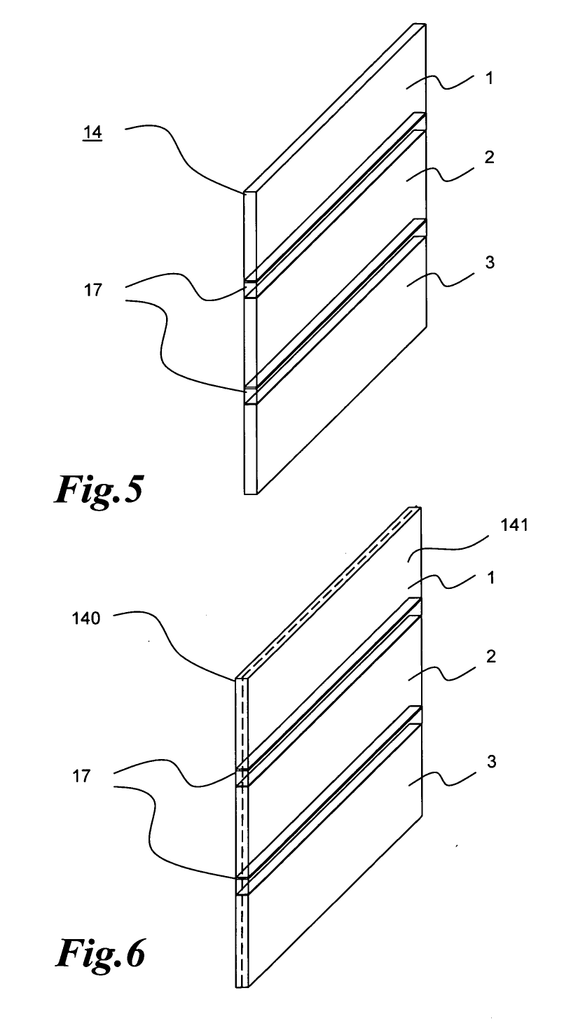

FIG. 3 shows the fuel cell stack 10, in which the individual electrically conducting components anodes, cathodes, electrolyte, bipolar plates and end plates are divided into three segments 1, 2, 3. The total resistance of the electrolyte and the bipolar plate is divided in the longitudinal direction into two parts, which are connected in the middle by lateral resistances, as can be seen in the equivalent circuit diagram in FIG. 4. A corresponding representation has been omitted for the other electrically conducting components for reasons of clarity. The lateral resistances are marked with the index “q”. They indicate that current can flow between the segments 1, 2, and 3 dependent on the size of the lateral resistance. The indices A and K again indicate the anode and cathode side. The first number in the index represents the segments i=1, 2 and 3, the second number the cell number, i.e. j=1 to n.

The inflowing fuel has the highest concentration in segment 1 and this has the result, that the equilibrium voltages of the electrochemical voltage sources U_{0,A,1j} and U_{0,K,1j} in segment 1 are the highest.

As the voltage difference between the poles respectively the end plates must be the same along all current paths, the current density in segment 1 is the greatest and so great, that the higher voltage drop in the resistances pf the individual fuel cell components caused by the higher current density compensates the higher equilibrium voltage. The higher current density of fuel cells in the area of the fuel inlet is a well known phenomenon. The respective current density in the segments 2 and 3 are correspondingly lower. As a result, the decrease of concentration of fuels along the path through the fuel cell from segment 1 to segment 2 and to segment 3 is not linear.

The heat development in a fuel cell is not only caused by ohmic losses along the current path and the charge transfer voltage, but also by the reversible heat of reaction. All three effects lead to a significantly higher heat development in segment 1 compared to segments 2 and 3. As a consequence there is a significant temperature gradient along the electrodes, which cannot be reduced much even if there is very good external cooling.

Table 1 and 2 show the result of a simulation of the current density and temperature distribution in a an exemplary fuel cell stack with six cells connected in series, whereby the total current is 90 A, ambient temperature is 303K, stationary conditions have been reached and all segments of all components have the same area. For the simulation the assumption has been made, that the equilibrium voltages U₀ depends on the local concentration, the fuel concentration in segment 2 corresponds to the inlet concentration minus the quantity of fuel which has been consumed for the current flowing in segment 1, and the fuel concentration in segment 3 is reduced compared to the concentration in segment 2 accordingly. Furthermore it is assumed, that the charge transfer resistance depends on the current according to the Butler-Volmer equation using conventional values as parameters, the heat generation takes the reversible heat of reaction into account and heat loss occurs only on the outside of the electrodes. Corresponding to FIG. 3, the heat loss in segment 2 is lowest as segment 2 has only a very small part of the outside wall, when taking figure e as a section through a rectangular fuel cell stack. In addition it is assumed that the ratio of through resistance to lateral resistance corresponds to he dimensions of length and area in conventional fuel cell stacks. Material inhomogeneities or other differences in the current paths are not taken into account in this simulation.

The temperature and current inhomogeneities in table 1 and 2 show quantitatively the problems which have been explained in the state of the art, whereby there is a maximum difference of 14 A between segments 1, 2 and 3 and a maximum temperature difference of 20 respectively 28 K. The temperature in segment 1 in the first cell and the sixth cell is identical and h and lies in the same range as the temperature in Segment 3 in the second, third, fourth and fifth cell. Further, there is the same temperature in the first and sixth cell in segment 2 and lies in the same range as the temperature in segment 1 in cells 2 to 5. The temperature in segment 3 is identical in cells 1 and 6. The highest temperature exists in segment 2 in cells 2 to 5.

TABLE 1

| Currents [A] | Cell 1 | Cell 2 | Cell 3 | Cell 4 | Cell 5 | Cell 6 |
|---|---|---|---|---|---|---|
| Segment 1 | 38 | 38 | 38 | 38 | 38 | 38 |
| Segment 2 | 27 | 27 | 27 | 27 | 27 | 27 |
| Segment 3 | 24 | 24 | 24 | 24 | 24 | 24 |
| maximum | 14 | 14 | 14 | 14 | 14 | 14 |
| difference [A] | | | | | | |

TABLE 2

| | Temperature [K] | | | | | |
|---|---|---|---|---|---|---|
| | Cell 1 | Cell 2 | Cell 3 | Cell 4 | Cell 5 | Cell 6 |
| Segment 1 | 352 | 365 | 365 | 365 | 365 | 352 |
| Segment 2 | 356 | 375 | 375 | 375 | 375 | 356 |
| Segment 3 | 336 | 347 | 347 | 347 | 347 | 336 |
| maximum | 20 | 28 | 28 | 28 | 28 | 20 |
| difference [K] | | | | | | |

The voltage drop across the individual resistance components along each segment depends on the current and the size of the resistances. The largest voltage drop occurs across the charge transfer resistance of the electrochemical voltage source and the electrolyte, and the lowest across the resistance of the bipolar plate. The simulation shows, that the voltage difference between segment 1 and 3 of the bipolar plate is negligibly small independent of the size of the lateral resistance, which can also be explained from symmetry reasons. Between the different areas of the end plate there are no voltage differences, because these are connected with low resistance via the current collecting cable. The simulation shows that the current inhomogeneity depends only very little of the lateral resistance of the bipolar plate respectively of the other components. The lateral conductivity only plays a role if their are faults or non-uniformities. Overall, the isotropic conductivity of all components should be as high as possible for a fuel cell stack according to FIG. 1.

The fuel cell stack shown in FIG. 1 is conceptionally an electrochemical energy conversion system, in which there is a voltage equalization between the different segments of a cell in each electrically well conducting component. In particular, there is no voltage difference in the electrically especially well conducting bipolar plate, but the current is very different between the segments.

According to the invention, voltage differences between the segments of the bipolar plates and the segments of the other electrically conducting components should be purposefully induced so that the current flowing in the individual segments can be influenced and made more homogeneous, which is achieved by the division of all components such as electrolyte, gas distribution layer, bipolar plate, etc., into segments which are electrically separated, as already shown in FIG. 3. In FIG. 5, a bipolar plate with a separation into three electrically separated segments is shown. The electrical insulating and preferentially thermally well conducting separating elements 17 should be as thin as possible, so that, if possible, the size of segments 1, 2 and 3 will not be reduced by maintaining the total area if the bipolar plates. The separating elements 17 are positioned on top of each other in a conventional assembly of cells in series

In FIG. 6 a modified bipolar plate 14 compared to the embodiment of FIG. 5 is shown, in which two half bipolar plates 140, 141 with equal area and equal thickness, which corresponds for instance to half the thickness of the bipolar plate, are provided.

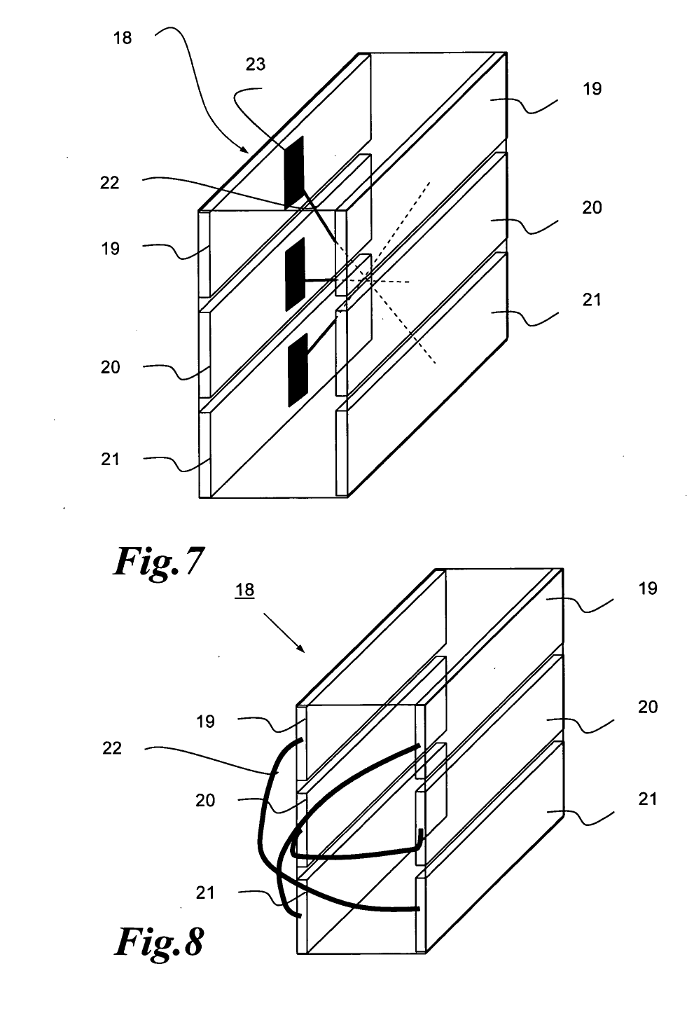

To create a more homogeneous current density distribution according to the invention, a transfer plate as shown in FIG. 7 is positioned between the two half bipolar plates 140 and 141, which enables current flow between different segments. As the bipolar plate can be modified and machined the most simple, it is sensible to combine the transfer plate spatially and functionally with a bipolar plate.

The transfer plate 18 consists of electrically non conducting material. The opposite surfaces of the transfer plate contain metallic, conducting sections 19, 20, 21, which must not touch each other. The respective areas of the section 19, 20, 21 of the individual segments 1, 2 and 3 exhibit approximately the same form and size as the segments of the neighboring half bipolar plates. They are only in contact with one segment of the half bipolar plate when aligned accordingly. Thus tow neighboring segments of the half bipolar plates cannot be in contact with each other via a section of the transfer plate. The electrically insulating boundaries of the segments of all components of the fuel cell stack are therefore located always at the same place.

The current from the conducting sections 19, 20, 21 is conducted to any other section 19, 20, 21, on the other side of the transfer plate 18 by means of a connecting element 22, e.g. a cable, which is soldered to the middle of the conducting contact area 23. In FIG. 7 three connecting cables 22 are shown, which guide the current from section 19 on the one side of the transfer plate 18 to section 21 on the other side of the transfer plate 18, as well as connecting cables 22, which lead from section 20 on the one side of transfer plate 18 to section 20 on the other side of the transfer plate and from section 21 on the one side of the transfer plate 18 to section 19 on the other side of the transfer plate 18.

Another embodiment of the connecting elements 22 shows FIG. 8. In this embodiment, the connecting cables 22 are attached at the side of the electrically conducting sections 19, 20, 21 of transfer plate 18. The current is thus conducted on the outside of the transfer plate from one section to another section.

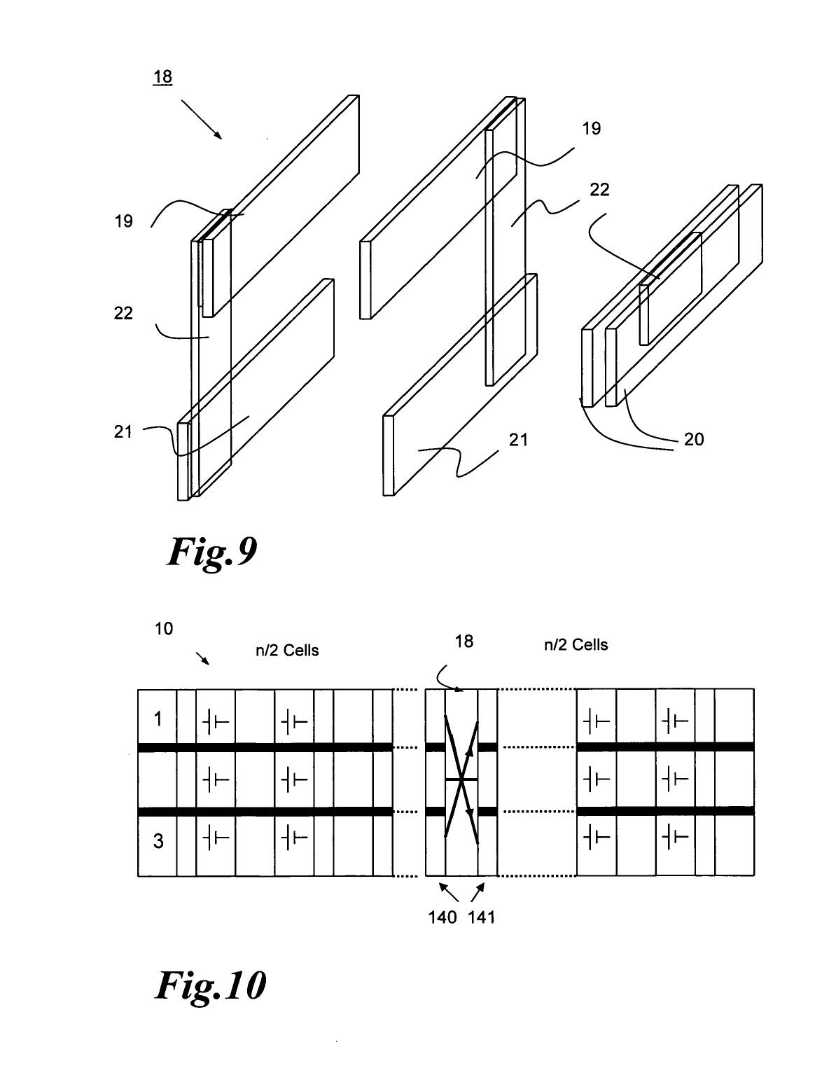

FIG. 9 shows an exploded view of the transfer plate 18 without the insulating base material in which the individual sections are embedded. It is obvious, that the individual sections 19, 20, 21 of the transfer plate and the connecting elements 22 can also be manufactured from one piece, for instance as stamped part. The connecting elements between the electrically conducting sections 19, 20, 21 and the sections themselves exhibit a low and very resistance value.

The transfer plate is positioned between the two half bipolar plates. The surfaces of the transfer plate 18, in particular their sections will be made advantageously in such a way that, simply by pressure, very good electrical contact will be made with the side of the half bipolar plates which do not face the membrane-electrolyte-assembly (MEA). A smooth surface treated surface both on the respective side of the half bipolar plate as well as on the transfer plate are especially suitable for this. Furthermore it is also possible to solder the transfer plate to the half bipolar plate or connect hem in any other from electrically and mechanically.

Alternatively it is possible to manufacture a bipolar plate in which the function of such a transfer plate is already integrated. A design engineering fusion of transfer plate and bipolar plate can be carried out for instance in such away that the electrically conducting sections of the transfer plate exhibit the same surface structure and surface treatment as the bipolar plate, that is in the area of the flow field, the inclusion of the gas diffusion layer, etc., and thus take on the function of the bipolar plate. It is therefore possible that a bipolar plate will take over the function of the transfer plate without particular modifications if the current should be conducted from one segment on one side to the same segment of the other side.

FIG. 10 shows exemplary the function of the transfer plate 18, which is placed in the middle of the fuel cell stack 10. If there is an even number of cells, then there will be the same number m=n/2 of cells on both sides of the transfer plate, if there is an odd number of cells, then there will be one cell less on one side of transfer plate 18. In the transfer plate, the current of segments 1 of cells 1 to m will be conducted into segment 3 of cells m+1 to n, and the current from segment 3 of cells 1 to m into segment 1 of cells m+1 to n. If n is an even number and m=n/2, then the voltage drop across the new current path 1-3 and 3-1 in sum is equal and thus the current must be equal.

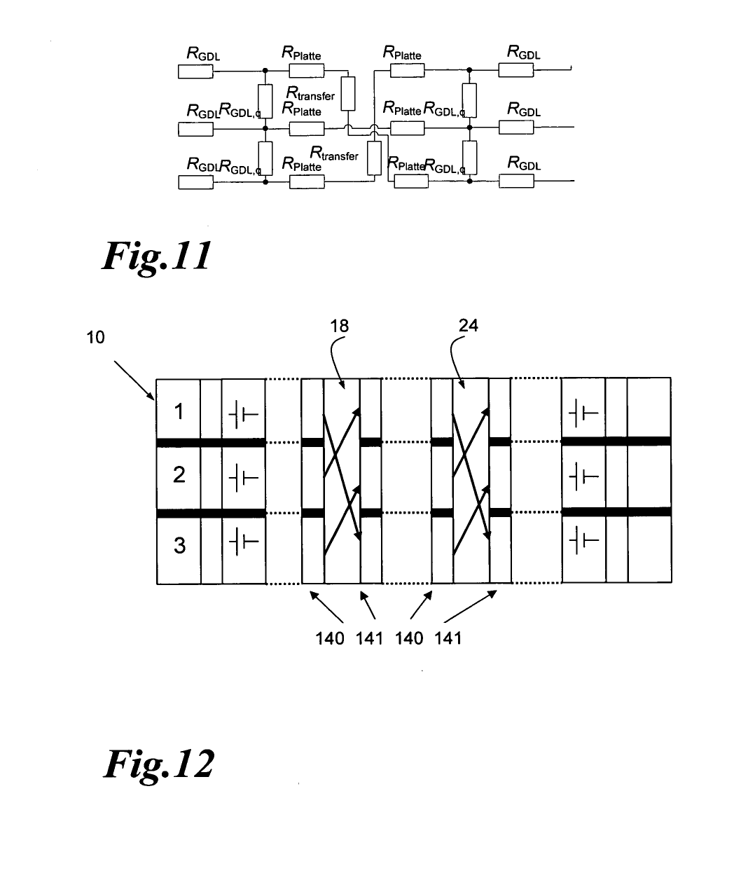

FIG. 11 shows the equivalent circuit diagram of Transfer plate 18 of FIG. 10. The resistance R_{transfer} of the transfer plate can be seen in the middle of the equivalent circuit diagrams.

The resulting simulation of the fuel cell system with such a bipolar plate with transfer plate is shown in table 3 and 4 using the same conditions as discussed above for table 1 and 2. It is immediately clear that a considerable current and temperature equalization compared to the situation without transfer plate (Table 1 and 2) has taken place. The maximum current difference is now only 3 A. The maximum temperature difference lies between 13 and 19 K.

By altering the areas of segments 2 at the expense of the areas of segments 1 and 3 the heat development can be changed, so that the temperature differences can be further reduced, however at the expense of the current homogeneity. The areas of the segments therefore do not have to be identical, but may vary depending on the optimization objectives. This concerns also the areas of segments 1 and 3 which may have different sizes, e.g. in order to reduce or increase the current density in the segment with the lowest fuel concentration in relation to the current density in the segment with the highest fuel concentration. Different sizes of the segments of the components in the individual cells, e.g. in order to compensate the different heat loss in the middle of the fuel cell stack and on both ends, offers further optimization potential.

TABLE 3

| Currents [A] | Cell 1 | Cell 2 | Cell 3 | Cell 4 | Cell 5 | Cell 6 |
|---|---|---|---|---|---|---|
| Segment 1 | 31 | 31 | 31 | 31 | 31 | 31 |
| Segment 2 | 28 | 28 | 28 | 28 | 28 | 28 |
| Segment 3 | 31 | 31 | 31 | 31 | 31 | 31 |
| maximum | 3 | 3 | 3 | 3 | 3 | 3 |
| difference [A] | | | | | | |

TABLE 4

| | Temperature [K] | | | | | |
|---|---|---|---|---|---|---|
| | Cell 1 | Cell 2 | Cell 3 | Cell 4 | Cell 5 | Cell 6 |
| Segment 1 | 344 | 356 | 356 | 356 | 356 | 344 |
| Segment 2 | 356 | 374 | 374 | 374 | 374 | 356 |
| Segment 3 | 343 | 355 | 355 | 355 | 355 | 343 |
| maximum | 13 | 19 | 19 | 19 | 19 | 13 |
| difference [K] | | | | | | |

FIG. 12 shows an alternative embodiment of a fuel cell stack 10 with two transfer plates 18, 24. Using a fuel cell stack with six cells and division into three segments 1, 2, 3, two identically designed transfer plates 18, 24 can be employed after two fuel cells each. The transfer plates 18, 24 conduct the current according to FIG. 12 from segment 1 into segment 3, the current from segment 2 to segment 1 and the current from segment 3 to segment 2. As a result there are three different current paths, whereby the current in each current path passes through segments 1, 2 and 3 twice in two cells. Because the cells are identical from their electrical construction, the current through all cells and current paths is also equal, except for the impact of the temperature. A simulation with the same conditions as already described above visualizes the results which are given in tables 5 and 6. In contrast to the example described above, there is a much better current homogeneity, however a poorer temperature homogeneity. The maximum difference between the currents flowing through the cells is in the range of 0.4 to 0.8 Ampere, whereby the maximum temperature difference lies between 15 and 22 K. The reason for this is the higher current density in segment 2 in the middle of the fuel cell stack, die therefore increased heat generation and, because of the same cooling conditions a higher temperature.

TABLE 5

| Currents [A] | Cell 1 | Cell 2 | Cell 3 | Cell 4 | Cell 5 | Cell 6 |
|---|---|---|---|---|---|---|
| Segment 1 | 30.5 | 30.4 | 30 | 30.2 | 30.2 | 30.3 |
| Segment 2 | 29.7 | 29.7 | 30.2 | 29.8 | 30.1 | 30 |
| Segment 3 | 29.8 | 29.8 | 29.8 | 30.1 | 29.6 | 29.6 |
| maximum | 0.8 | 0.7 | 0.4 | 0.4 | 0.6 | 0.7 |
| difference [A] | | | | | | |

TABLE 6

| | Temperature [K] | | | | | |
|---|---|---|---|---|---|---|
| | Cell 1 | Cell 2 | Cell 3 | Cell 4 | Cell 5 | Cell 6 |
| Segment 1 | 342 | 352 | 352 | 352 | 352 | 342 |
| Segment 2 | 356 | 373 | 373 | 374 | 373 | 356 |
| Segment 3 | 341 | 352 | 352 | 353 | 353 | 341 |
| maximum | 15 | 21 | 21 | 22 | 21 | 15 |
| difference [K] | | | | | | |

The effect of the transfer plates can be clearly recognized, i.e., that by their use it can be achieved that there are the identical electrical conditions along each current path, and that the current in each current path is equal. The concentration of fuel does not decrease along its path through the fuel cell proportionally to the respective concentration, but is always reduced by the amount corresponding to the current density. The heat development along each current path remains constant, whereby the heat development must not be taken to be the same as the temperature development, because the heat loss over the outside surfaces of the individual segments are different. In a directly cooled bipolar plate, for instance, the cooling in the middle of the fuel cell stack is quite good, however, even then temperature inhomogeneities can be expected. This means that the temperature under conditions of equal current density and equal heat generation is highest, where the heat transfer surfaces are smallest. When segmenting a fuel cell into three parallel sections, this leads to the temperature development being highest in the middle segment.

In particular for high temperature fuel cells (SOFC and MCFC), the temperature homogeneity plays an important role, because inhomogeneities can have a particularly negative effect. The size and shape of the areas of the segments of the components of the individual cells is an optimization goal depending on the position of the cell in the stack. If temperature homogeneity is achieved, then the temperature gradient within the fuel cell stack is also reduced, resulting in lower thermal stress.

The number of transfer plates, the number of segments and the size of the area of the segments, as well as details of connecting the current path through the transfer plates can be altered application specific to achieve a uniform current density and to create a homogeneous temperature field.

To achieve a further reduction of the current inhomogeneity within each segment, the number of segments can be increased. Practically the number of segments should not be higher than the number of cells connected in series, as advantageously each current path should be conducted through all segments of the cells. When using a larger number of segments, this would no longer be possible. Ideally the current path will pass through each segment of the cells equally frequent. For a 40 cell fuel cell stack the optimal number of segments, into which cells should be divided is therefore 40, 20, 10, 8, 5, 4 or 2, in addition to segments, whose current will be passed through the connecting elements in a transfer plate to the same segment on the other side of the transfer plate (such as, for instance, segment 2 in FIG. 10).

For cost reasons it is desirable on principle to keen the number of segments and the number of transfer plates as low as possible. The above examples show that a considerably more homogeneous current and temperature distribution can be achieved, when the current is not passed by the transfer plates in all segments to other segments, but instead is only passed through those segments, which exhibit a particular high or low current density without intervention. An optimal uniformity depends on the details of the flow field, the operating conditions and in particular the load dynamics.

The above described simulations show that the size of the resistances of the separating elements 17, which separate the bipolar plates and other components into segments, which are electrically insulated and separated from each other, plays only a minor role for the results shown in table 3, 4 and 5, 6. The through resistance of the individual components is determined by a very large cross section and a very small thickness, whereas the lateral resistance is determined by a very small area and a large length. For conventional fuel cell stack designs therefore the differences between the through resistance and lateral resistance is very high. The results shown in table 3, 4 and 5, 6 have been calculated with the lateral resistance values that can be expected and not with an electrically complete separation between the segments. Although the waiver of the separating elements in case of sufficiently high lateral resistance in relation to the through resistance leads to a considerable simplification in design, the use of separating elements leads to obvious advantages, because the current flow from one segment to the next occurs then exclusively occurs in the transfer plate and there are no parasitic lateral currents to other segments, which may occur in particular in the electrically well conducting bipolar plate. As alternative to separating elements it may be appropriate to use for the bipolar plate a material, which is electrically anisotropic or can be manufactured to be anisotropic, so that the resistance in the through direction is as low as possible but higher in the lateral direction and the parasitic effects in the bipolar plates without the use of transfer plates is reduced. The anisotropy can also be used in the through direction of the bipolar plate and e.g. create the chosen boundaries of the segments. When manufacturing a bipolar plate from graphite, the boundaries of the segment can, for instance be manufactured by using poorly conducting platelets, which reduce the lateral conductivity without reducing the through conductivity in a similar manner. When using metallic bipolar plates, a corresponding local change of conductivity can be achieved by selectively removing material locally, local material inhomogeneities or local changes of material properties.

When defining the segments and the transfer plates appropriately, it is also possible to reduce the impact of the skin effect and the transient skin effect, similar to the use of twisted conductors or the Roebel rod which is used in electrical machines for reducing current displacement effects, as described, for instance in U.S. Pat. No. 1,653,784 A and pm the website of the company ABB http://www.abb.de. At least one segment will be advantageously arranged in the middle of a cell, surrounded by the other segments. The current path through the fuel cell stack is specified by the transfer plates in such a way that each current path passes both through segments on the outside as well as through segments in the inside of the stack.

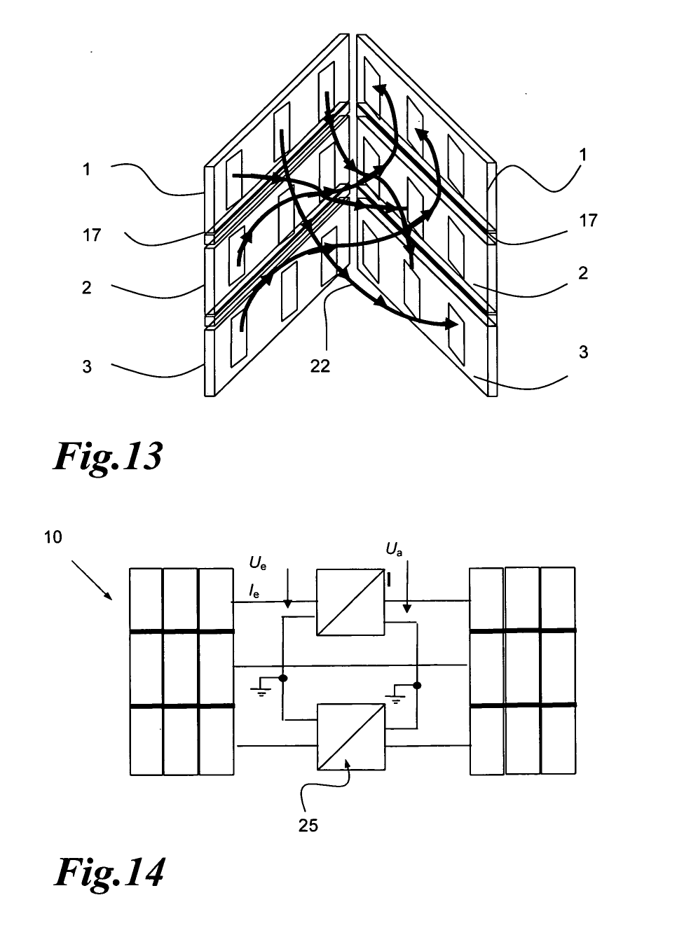

To ensure that the fuel cell stack will not exhibit a transient skin effect even in parts of a segment, it will be advantageous to switch the current path relatively frequently from the outside to the inside. An embodiment for this is shown in FIG. 13. Here the current paths are is interchanged, whereby not all connecting elements between the segments on both sides of the transfer plate have been shown in FIG. 13 for reasons of clarity. For an optimal adaptation to the respective application, a variation concerning the material properties, such as, the permeability, especially of nickel or iron containing steels, the thickness of each cell, the number of cells and the current gradient in case of switching operations should be carried out. The transient skin effect furthermore depends on the electrical conductivity vertical to the main direction of the current. This conductivity can be reduced by using anisotropic conducting materials for the manufacture of bipolar plates, as described above.

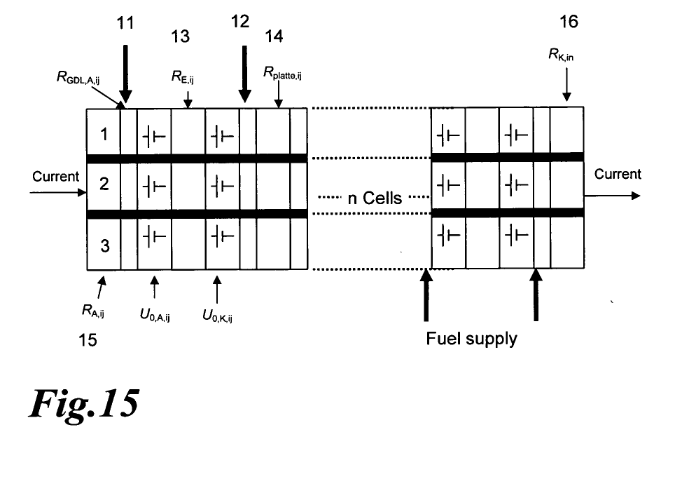

Alternatively to the above described provision of a transfer plate or possibly also additionally, the current density distribution can also be modified by supplying fuel to the individual cells of a fuel cell stack to different segments. In FIG. 15 the schematical representation of a fuel cell stack as in FIG. 3 is shown, whereby the fuel flows into segment 1 on one side of the stack, from there into segment 2, from there into segment 3 and from there to the outlet of the fuel cell stack, while the fuel is supplied to the other side of the stack or the next cell to segment 3, from there to segment 2, then segment 1 and from there to the outlet of the fuel cell stack. The separation of the components of the fuel cell stack into segments by means of non conducting separating elements or the low lateral conductivity of the components leads to electrical equivalent current paths. If the fuel supply to a stack with n cells is carried out to n/2 Cells into segment 1 and for the cells n/2+1 to n into segment 3, respectively in the first m cells into segment 1, in the next m cells into segment 3, and so on with m being advantageously equals 1, then the electrical conditions of current path 1-3 and 3-1 are equal and there is a corresponding improvement of the current homogeneity. If there are more segments the fuel supply can be carried out instead of from two different directions from additional directions and in all current paths electrically equivalent conditions are created. In contrast to the state of the art, the supply of fuel to the individual segments can be varied from cell to cell. Simulation results for this correspond qualitatively to those of table 3 and 4 and are therefore not shown here. Instead of fuel supply to fuel cells, the above description also applies to reactants of other electrochemical energy conversion systems, such as, for instance, galvanic plants and electrolysers.

The explanations so far have only referred to electrochemical energy conversion systems in the general form of a bipolar system, in particular fuel cells. For electrochemical energy conversion system in the general form of a monopolar cell, consisting of a number of cathodes and anodes which are connected in parallel in one container filled with electrolyte. the description so far are also valid, when group bars with at least two segments, which are separated electrically or by means of high lateral resistance are used, whereby all cathodes are connected to one group bar and all anodes are connected to s second group bar.

Alternatively to the above described provision of a transfer plate and/or the assignment of the fuel supply to a specific segment, or if possible also in addition to these, the current density distribution can also be modified actively by means of a power electronic components, such as a buck or boost DC-converter. An example of a part of a fuel cell stack with such a buck or boost converter 25 is shown in FIG. 14. The current density in the segments respectively the potential of the segments versus a reference electrode, in the most simple case a common ground potential, is measured and according to the optimization objective, e.g. maximum power, highest current density or temperature homogeneity, maximum efficiency etc., the current density and/or the potential of the respective segment will be converted upwards or downwards by means of a power electronic component. The power electronics components can be realized simply either between two cells or, which is simpler from a design point of view, at the beginning or end of a fuel cell stack. In the latter case it is helpful, if an insulating connection to the individual segments is possible, e.g. by the segmentation of an end plate, to which the power electronic components can be connected,

The function of the power electronic component in a fuel cell stack can be explained using the following example:

Tables 1 and 2 show that the current in segment 1 is higher (38 A) and in segment 3 lower (24 A) than the arithmetic average (30 A) of the total current in the three segments. In order to achieve a uniform current distribution, it is necessary, to reduce the current in segment 1 and to increase the current in segment 3. For the operation of the power electronic component as converter in segment 1, the output voltage is increased from Uₑ to auf Uₐ and the following ratio can be used:

$${U}_{a} = {U}_{e} \frac{T}{T - {T}_{ein}}$$

whereby Tₑᵢₙ is the ontime of an inductance of a conventional converter and T is the duration of the switching operation.
Under the condition Pₑᵢₙ=Pₐᵤₛ follows:

$${I}_{e} = {I}_{a} \frac{{U}_{a}}{{U}_{e}} = {I}_{a} \frac{T}{T - {T}_{ein}} .$$

From this follows the duty cycle of the converter for the reduction of the current in segment 1:

$$\frac{{T}_{ein}}{T} = 1 - \frac{{I}_{a}}{{I}_{e}}$$

If the optimization goal is the current homogeneity, then Iₐ can be set equal to the arithmetic mean.

The voltage increase (Uₐ−Uₑ) caused by the inverter leads to a reduction of the current in segment 1. The reduction of the current in segment 1 leads to a reduction in fuel consumption in segment 1 and thus more fuel enters into the other segments. As a consequence, the concentration dependent voltages increase in each of the subsequent segments of each fuel cell of the stack and therefore also the current and correspondingly the power. Changing the current in one individual segment therefore also influences the current in each of the subsequent cells. By reducing the current in one segment and increasing the current in another segment, the result is a “power displacement” from one segment to another. The effect of the converter in segment 1 will be supported by this. Correspondingly it may be appropriate to carry out the respective voltage conversion in segment 3. The current in segment 2 does not be actively influenced if the fuel cell stack is divided into three parts and the current will be the result of Kirchhoffs laws. Of course it would also be possible to intervene in segment 2 and introduce a DC converter which would then have to be a buck or boost converter depending on the application and operation.

In addition to the above described and in the drawings represented embodiments of the electrochemical energy conversion systems with electrically conducting components with at least two cells connected in series further embodiments exist, in which at least one electrically conducting component is divided into at least two segments which are insulated from each other, for a current and/or temperature equalization within the electrochemical energy conversion system. Furthermore a transfer plate consisting of electrical non-conducting material with at least two electrically conducting sections or areas on both sides is provided, in order to conduct current from one segment to another. Alternatively or additionally the current equalization can be provided by means of a segment specific fuel supply and or at least one power electronic component.

### ASSIGNMENT LIST

1 first segment
2 second segment
3 third segment
10 Fuel cell stack
11 Anode
12 Cathode
13 Electrolyte
14 Bipolar plate
15 Anode end plate
16 Cathode end plate
17 Separating element
18 Transfer plate
19 electrically conducting section
20 electrically conducting section
21 electrically conducting section
22 Connecting element
23 Connection region
24 Transfer plate
25 Buck and/or boost converter
140 Half bipolar plate
141 Half bipolar plate

What is claimed is:

1. An electrochemical energy conversion system comprising: at least one electrically conducting component with at least two in series connected cells,
wherein at least one of the electrically conducting components is divided into at least two segments, which are electrically insulated against each other and at least one transfer plate is provided, consisting of electrically non-conducting material with at least two conducting sections and/or areas for conducting current from at least one segment to at least one other segment.

2. The electrochemical energy conversion system according to claim 1, wherein at least one electrically insulating separating element is present between each segment.

3. The electrochemical energy conversion system according to claim 1, wherein at least one electrically conducting component is divided into at least two half components which are connected via a transfer plate electrically conducting with each other.

4. The electrochemical energy conversion system according to claim 3, wherein when using a bipolar plate as electrically conducting component, the half components are half bipolar plates.

5. The electrochemical energy conversion system according to claim 3, wherein the transfer plate is placed between the two half components.

6. The electrochemical energy conversion system according to claim 1, wherein only one electrically conducting component is a bipolar plate of a fuel cell stack or the electrodes of a galvanic plant, an electrometallurgical plant or an electrolyser are divided electrically into segments.

7. The electrochemical energy conversion system according to claim 2, wherein a bipolar plate is used as the separating element which has a lateral resistance along the length of the bipolar plate which is much higher than the through resistance by a factor of 10³ to 10⁵.

8. The electrochemical energy conversion system according to claim 1, wherein the electrically conducting component is a bipolar plate of a fuel cell stack or the electrodes of a galvanic plant, an electrometallurgical plant or an electrolyser, consisting of an electrically anisotropic conducting material.

9. The electrochemical energy conversion system according to claim 8,
wherein the electrically conducting component consists of a material whose electrical conductivity in the direction vertical to the surface area is high and in the other directions lower.

10. The electrochemical energy conversion system according to claim 9,
wherein a specific conductivity in the through direction is at least double as much as in the lateral direction.

11. The electrochemical energy conversion system according to claim 8,
wherein the anisotropy of the electrical conductivity of the electrically conducting component that is the bipolar plate, exhibits a preferential direction so that the lateral conductivity between the individual segments is at least halved.

12. The electrochemical energy conversion system according to claim 8, wherein a specific lateral conductivity of the electrically conducting component that is the bipolar plate, decreases in radial direction from the middle by at least a factor of 4 compared to the through conductivity so that a transient skin effect can be avoided.

13. The electrochemical energy conversion system according to claim 1, wherein the electrically conducting sections of the transfer plate are separated electrically from one another.

14. The electrochemical energy conversion system according to claim 1, wherein the electrically conducting sections and/or areas of the transfer plate are provided with electrical separation from one another and a lateral resistance forms a separating element between the electrically conducting sections and/or areas.

15. The electrochemical energy conversion system according to claim 1, wherein connecting elements are provided between the electrically conducting sections and/or areas of the transfer plate and which are insulated against each other.

16. The electrochemical energy conversion system according to claim 15, wherein the connecting elements are cables, in particular when providing a number of cables whose resistance corresponds to each other and is similar.

17. The electrochemical energy conversion system according to claim 15, wherein the connecting elements are essentially flat elements, which are connected with the conducting sections and/or areas of the transfer plate, with similar or identical resistance.

18. The electrochemical energy conversion system according to claim 15, wherein the connecting elements are arranged outside of the transfer plate, in order to conduct current from one segment to another segment.

19. The electrochemical energy conversion system according to claim 15, wherein the connecting elements are connected to an electrical center of the sections or at a place, from which a current density can be passed on with lowest resistance between the sections, which are connected to one another and taking the resistance of the sections themselves into account.

20. The electrochemical energy conversion system according to claim 15, wherein the connecting elements which can be or are fastened to predefined locations at or on the transfer plate.

21. The electrochemical energy conversion system according to claim 1, wherein a non conducting body of the transfer plate is constructed in part as a hollow body filled with air or fuel.

22. The electrochemical energy conversion system according to claim 1, wherein the transfer plate is arranged between two parts of an electrochemical energy conversion system, in particular stacks of a fuel cell, and that instead of half bipolar plates with separating elements end plates with separating elements or group bars with separating elements are provided, in particular separating elements which are electrically insulating or formed as a result of a lateral resistance.

23. The electrochemical energy conversion system according to claim 1, wherein at least one segment is surrounded by all other segments.

24. The electrochemical energy conversion system according to claim 23, wherein a connection for conducting current between the segments both between the other segments as well as the inner segments is provided.

25. The electrochemical energy conversion system according to claim 1, wherein the transfer plate is formed together with at least one bipolar plate together as an integral, design engineered unit.

26. The electrochemical energy conversion system according to the claim 1, wherein at least one power electronic component is provided for improving current homogeneity in an electrochemical energy conversion system.

27. The electrochemical energy conversion system according to claim 26, wherein the power electronic component is integrated into at least one current path of segments of the electrically conducting components, or which can be integrated.

28. The electrochemical energy conversion system according to claim 26, wherein the power electronic component passes power taken up onto at least one electronic component between segments and/or provides the power for operation of auxiliary systems.

29. The electrochemical energy conversion system according to claim 1, wherein an end plate of the electrochemical energy conversion system is provided, which is divided into segments which are electrically separated from one another.

30. The electrochemical energy conversion system according to claim 29, wherein a power electronic component is arranged on the side of the end plate which is facing away from the fuel cell stack.

31. The electrochemical energy conversion system according to claim 1, wherein the segments have different sizes and are variable from cell to cell.

32. The electrochemical energy conversion system according to claim 1, wherein a supply of fuel or reactants to an electrochemical energy conversion system in the form of a fuel cell is fed to the cells to different segments in different sequences.

33. A transfer plate for an electrochemical energy conversion system according to claim 1, wherein the transfer plate consists of electrically non-conducting material and has at least two electrically conducting sections and/or areas.

34. The transfer plate according to claim 33, wherein at least two electrically conducting sections and/or areas are provided on both sides of the transfer plate.

35. The transfer plate according to claim 33, wherein connecting elements are provided, which connect the sections and/or areas with one another.
